(19) United States
(12) Patent Application Publication
(10) Pub. No.: US 2007/0091871 A1
(43) Pub. Date: Apr. 26, 2007

(54) Mesh network portal node and method for bridging in mesh networks

(75) Inventor: Samer Taha, Beaverton, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/258,737

(22) Filed: Oct. 26, 2005

(51) Int. Cl. H04L 12/56; H04L 12/66

(52) U.S. Cl. 370/352; 370/401

(57) ABSTRACT

Embodiments of a mesh portal node and method for bridging in wireless mesh networks are generally described herein. Other embodiments may be described and claimed. In some embodiments, a mesh portal node generates a proxy route request message on behalf of a source node in response to receipt of an initial route request message, sends the proxy route request message to a plurality of mesh networks, and sends a proxy route reply message on behalf of a destination node to the source node in response to receipt of an initial route reply message from the destination node.

### TECHNICAL FIELD

Some embodiments of the present invention pertain to wireless communications. Some embodiments of the present invention pertain to mesh networks. Some embodiments of the present invention pertain to layer-2 routing.

### BACKGROUND

A bridge is used to provide communications between two or more local area networks (LANs). Some conventional bridges operate at layer 2 of the open systems interconnection (OSI) reference model and serve as a physical connection between networks. Conventional bridges generally use a bridging table to track the port through which each destination is reachable and a spanning tree is used to help eliminate loops caused by redundant bridge ports. In wireless mesh networks, it is difficult for bridges to track and learn destinations from the traffic to and from nodes within the mesh networks because of the potential mobility of mesh points among different mesh networks. Conventional LAN bridges rely on media access control (MAC) frame broadcasting to learn network addresses; however this technique is very costly in a wireless environment because of bandwidth and power limitations. Thus, there are general needs for providing bridging among networks including wireless mesh networks and conventional LANs.

### BRIEF DESCRIPTION OF THE DRAWINGS

FIG. 1 illustrates a plurality of networks coupled with mesh portal nodes in accordance with some embodiments of the present invention;

FIG. 2A is a functional block diagram of a mesh portal node in accordance with some embodiments of the present invention;

FIG. 2B illustrates a bridging table in accordance with some embodiments of the present invention;

FIG. 2C illustrates a layer-2 routing table in accordance with some embodiments of the present invention;

FIG. 2D illustrates a bridging requests table in accordance with some embodiments of the present invention; and

FIGS. 3, 4, 5 and 6 are flow charts of port discovery, bridging and routing procedures in accordance with some embodiments of the present invention.

### DETAILED DESCRIPTION

The following description and the drawings illustrate specific embodiments of the invention sufficiently to enable those skilled in the art to practice them. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. Embodiments of the invention set forth in the claims encompass all available equivalents of those claims. Embodiments of the invention may be referred to, individually or collectively, herein by the term “invention” merely for convenience and without intending to limit the scope of this application to any single invention or inventive concept if more than one is in fact disclosed.

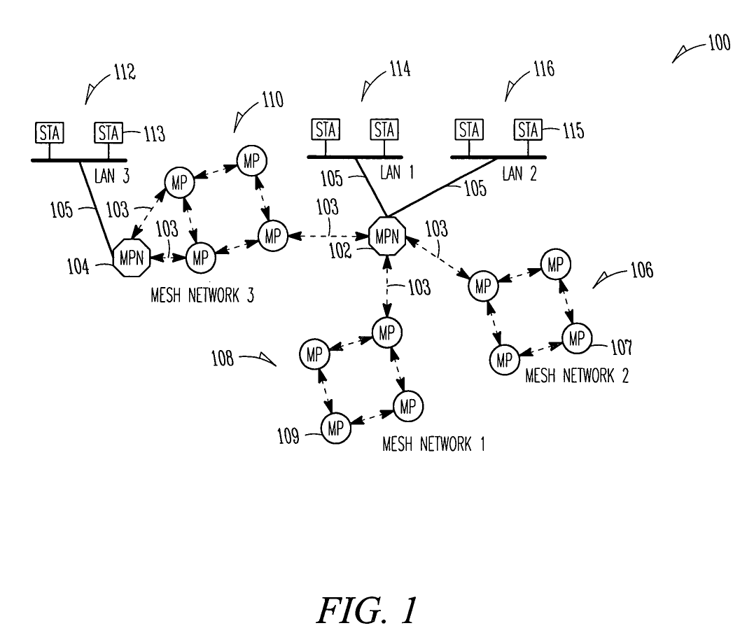

FIG. 1 illustrates a plurality of networks coupled with mesh portal nodes in accordance with some embodiments of the present invention. Networking environment 100 includes wireless mesh networks, generally shown as networks 106, 108 and 110, (e.g., Mesh Network 1, Mesh Network 2, and Mesh Network 3, respectively) which may communicate through mesh portal node (MPN) 102. Networking environment 100 also includes local area network (LAN) 112 (e.g., LAN 3), which may communicate with wireless mesh network 110 through mesh portal node 104. Networking environment 100 also includes LAN 114 and LAN 116 (e.g., LAN 1 and LAN 2), which may communicate with each other and with wireless mesh networks 106, 108 and 110 through mesh portal node 102. In some embodiments, LANs 112, 114 and 116 may be Ethernet LANs, although the scope of the invention is not limited in this respect. Wireless mesh networks 106, 108 and 110 may include one or more mesh points (MPs), which may be individual wireless communication devices described in more detail below.

In some embodiments, wireless mesh network 108 includes a plurality of mesh points, including mesh point 109, and wireless mesh network 106 includes a plurality of mesh points, including mesh point 107. Although FIG. 1 shows wireless mesh networks 106, 108 and 110 as having four mesh points, the scope of the invention is not limited in this respect as wireless mesh networks 106, 108 and 110 may include many mesh points. LANs 112, 114 and 116 may include a plurality of LAN stations (STAs). Although FIG. 1 shows LAN 112 comprising two LAN stations including LAN station 113, LAN 114 comprising two LAN stations, and LAN 116 comprising two LAN stations including LAN station 115, the scope of the invention is not limited in this respect as LANs 112, 114 and 116 may include many LAN stations.

In some embodiments, mesh portal nodes 102 and 104 may communicate over wireless links 103 with nodes or mesh points of the wireless mesh networks. In some embodiments, mesh portal nodes 102 and 104 may communicate with LANs over wired links 105.

In some embodiments, mesh portal nodes 102 and 104 may transparently translate layer-2 routing control packets of reactive routing between multiple bridged wireless mesh networks. This may enable multiple bridged wireless mesh networks to behave as a single larger wireless mesh network from the perspective of a layer-2 routing protocol. In some embodiments, mesh portal nodes 102 and 104 may behave as proxy layer-2 routing devices for other bridged networks (whether wireless or wired). Transparent and efficient bridging functionality may be achieved over conventional bridging techniques by reducing and/or eliminating the need to broadcast data frames over a wireless mesh network to perform bridging activities.

In accordance with some embodiments, mesh portal nodes 102 and 104 may transparently translate route requests, route replies and route errors between multiple bridged mesh networks while performing bridge learning. In some embodiments, mesh portal nodes 102 and 104 may transparently translate ad-hoc on-demand distance vector (AODV) route requests (RREQ), route replies (RREP), and route errors (RERR) between multiple bridged mesh networks while performing bridge learning, although the scope of the invention is not limited in this respect.

In some embodiments, mesh portal nodes 102 and 104 may utilize a reverse address resolution protocol (RARP) to enable mesh portal nodes 102 and 104 to perform a proxy function when communicating with other local area network technologies. This may allow wireless mesh networks 106, 108 and 110 to appear as a one hop LAN segment, although the scope of the invention is not limited in this respect.

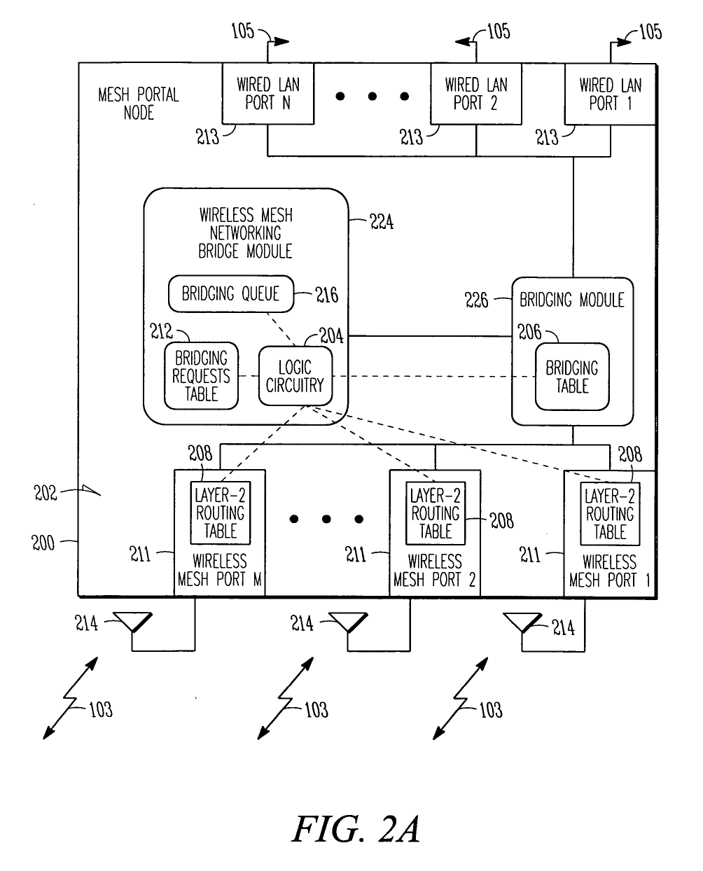

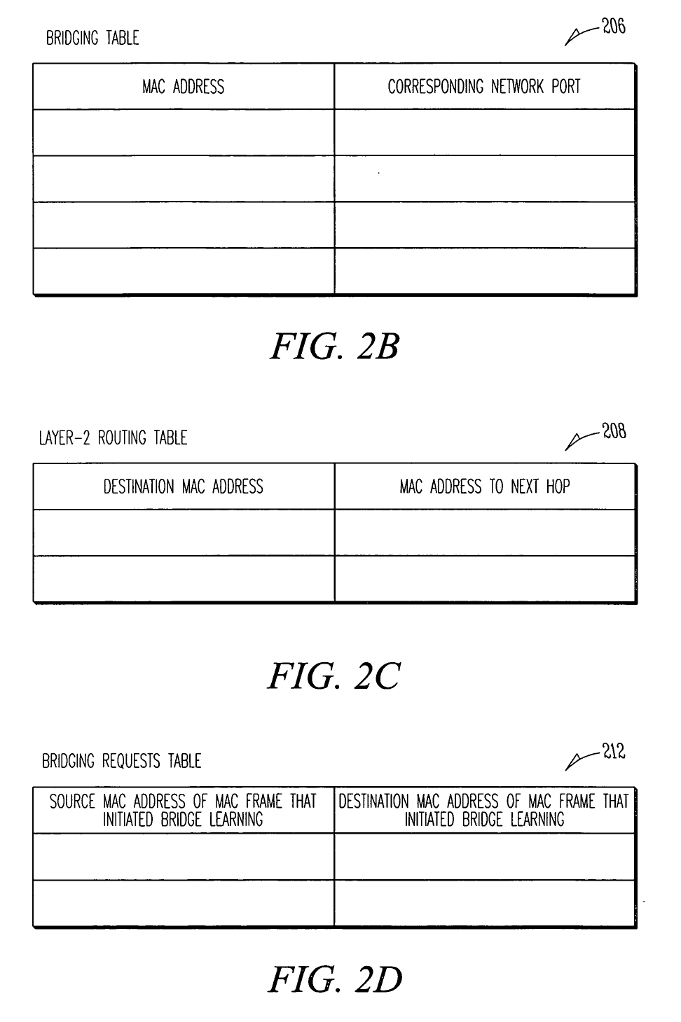

FIG. 2A is a functional block diagram of a mesh portal node in accordance with some embodiments of the present invention. Mesh portal node 200 may be suitable for use as either mesh portal node 102 (FIG. 1) and/or mesh portal node 104 (FIG. 1), although other configurations may also be suitable. Mesh portal node 200 comprises one or more wireless mesh ports 211, which may communicate over wireless links 103 (FIG. 1) with wireless mesh networks using antennas 214. Mesh portal node 200 also comprises one or more wired LAN ports 213, which may communicate over wired links 105 (FIG. 1) with local area networks. Ports 211 and 213 may be part of physical (PHY) layer 202 of mesh portal node 200. In some embodiments, the number (N) of wired LAN ports 213 and the number (M) of wireless mesh ports 211 may range from as few as one to up to ten or more.

At the media access control (MAC) layer, mesh portal node 200 also comprises wireless mesh networking bridge module 224 and bridging module 226 discussed in more detail below. Wireless mesh networking bridge module 224 may include logic circuitry 204, bridging requests table 212 and bridging queue 216. Bridging module 226 may include bridging table 206. Each of wireless mesh ports 211 may include one of layer-2 routing tables 208 as illustrated. In some embodiments, one or more memory structures may be used to store layer-2 routing tables 208, bridging table 206 and bridging requests table 212, among other things, within mesh portal node 200.

FIG. 2B illustrates a bridging table in accordance with some embodiments of the present invention. FIG. 2C illustrates a layer-2 routing table in accordance with some embodiments of the present invention. FIG. 2D illustrates a bridging requests table in accordance with some embodiments of the present invention. Bridging table 206 (FIG. 2B) associates MAC addresses with network ports. Although FIG. 2B depicts four entries, the bridging table 206 may include additional or fewer entries. Layer-2 routing table 208 (FIG. 2C) associates destination MAC addresses with MAC addresses to the next hop. Although FIG. 2C depicts two entries, the layer-2 routing table 208 may include additional or fewer entries. Bridging requests table 212 (FIG. 2D) associates source and destination MAC addresss of a MAC frame that initiated bridge learning. Although FIG. 2D depicts two entries, the bridging request table 212 may include additional or fewer entries. The use of these tables is described in more detail below.

In some embodiments, as part of the bridging functionality supported by mesh portal node 200, bridging table 206 associates each learned layer-2 destination address (e.g., a MAC address) and a port. This port may be a network port to a LAN or a wireless transceiver communicating with another mesh network. Bridging requests table 212 may be maintained by mesh portal node 200. When mesh portal node 200 receives a MAC data frame with a destination address that is not in its bridging table, it may attempt to discover the correct port for the destination address as described below. When mesh portal node 200 starts the port discovery process, it may save the destination address that it is trying to locate a port for in addition to saving the source address of the pending frame in bridging requests table 212. Each entry in bridging requests table 212 includes the source and destination addresses that correspond to a received frame where mesh portal node 200 does not know the port for the destination of that frame. When a new entry is added to bridging table 206, the mesh portal node checks the destination addresses in bridging requests table 212. When a match is found, mesh portal node 200 may delete the corresponding entry and may take other actions as described in more detail below.

In some embodiments, mesh portal node 200 may maintain bridging queue 216 (FIG. 2A) to queue MAC data frames received from bridged LAN segments when there is no entry for the destination in bridging table 206 or there is no active path in layer-2 routing table 208 for the destination in the bridged mesh network identified by bridging table 206. These embodiments are described in more detail below.

In some embodiments, mesh portal node 200 may transmit multicarrier communication signals, such as orthogonal frequency division multiplexed (OFDM) communication signals, over a multicarrier communication channel, which may be within a predetermined frequency spectrum. The multicarrier communication signals may comprise a plurality of orthogonal subcarriers. In some embodiments, the orthogonal subcarriers may be closely spaced OFDM subcarriers. To help achieve orthogonality between the closely spaced subcarriers, each subcarrier may have a null at substantially a center frequency of the other subcarriers and/or each subcarrier may have an integer number of cycles within a symbol period, although the scope of the invention is not limited in this respect.

In some embodiments, the frequency spectrums for a multicarrier communication signal may comprise either a 5 GHz frequency spectrum or a 2.4 GHz frequency spectrum. In these embodiments, the 5 GHz frequency spectrum may include frequencies ranging from approximately 4.9 to 5.9 GHz, and the 2.4 GHz spectrum may include frequencies ranging from approximately 2.3 to 2.5 GHz, although the scope of the invention is not limited in this respect, as other frequency spectrums are also equally suitable. In some broadband embodiments, the frequency spectrum for communications may comprise frequencies between 2 and 11 GHz, although the scope of the invention is not limited in this respect.

In some embodiments, mesh portal node 200 may transmit and receive radio-frequency (RF) communications in accordance with specific communication standards, such as the Institute of Electrical and Electronics Engineers (IEEE) standards including the IEEE 802.11(a), 802.11(b), 802.11(g) and/or 802.11(h) standards for wireless local area networks (WLANs) and/or the IEEE 802.11(s) standard for mesh networks, although mesh portal node 200 may also be suitable to transmit and/or receive communications in accordance with other techniques including the Digital Video Broadcasting Terrestrial (DVB-T) broadcasting standard, and the High performance radio Local Area Network (HiperLAN) standard. In some broadband and Worldwide Interoperability of Microwave Access (WiMax) embodiments, mesh portal node 200 may transmit broadband wireless communications in accordance with the IEEE 802.16-2004 standard for wireless metropolitan area networks (WMANs) including variations and evolutions thereof (e.g., IEEE 802.16(e)). For more information with respect to IEEE 802.11 standards, please refer to “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and related amendments/versions.

In some embodiments, mesh portal node 200 may be part of a wireless access point (AP), such as a Wireless Fidelity (WiFi), WiMax, or broadband communication station, although the scope of the invention is not limited in this respect as mesh portal node 200 may be part of almost any wireless communication device. In some embodiments, mesh portal node 200 and/or one or more of the mesh points within the wireless mesh networks may be part of a portable wireless communication device, such as personal digital assistant (PDA), a laptop or portable computer with wireless communication capability, a web tablet, a wireless telephone, a wireless headset, a pager, an instant messaging device, a digital camera, an access point, a television or other device that may receive and/or transmit information wirelessly.

Antennas 214 (FIG. 2A) may comprise one or more directional or omnidirectional antennas, including, for example, dipole antennas, monopole antennas, patch antennas, loop antennas, microstrip antennas or other types of antennas suitable for transmission of RF signals.

Although mesh portal node 200 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), and combinations of various hardware and logic circuitry for performing at least the functions described herein. In some embodiments, the functional elements of mesh portal node 200 may refer to one or more processes operating on one or more processing elements.

In accordance with some embodiments, when mesh portal node 200 receives a layer-2 AODV RREQ control packet through a specific mesh network port, mesh portal node 200 learns that the mesh point with the MAC address included as the source address in the RREQ packet may be reached through that specific mesh network port. Similarly, when it receives a layer-2 AODV route reply control packet through a specific mesh network port, it learns that the mesh point with the MAC address included as the destination address in the route reply control packet may be reached through that specific mesh network port. When a mesh portal node hears or receives a MAC frame through a specific LAN network port, it learns that the LAN node with the MAC address included as the sender address in the MAC frame may be reached through that specific LAN network port.

In some embodiments, mesh portal node 200 supports spanning tree formation. In these embodiments, spanning tree bridging control packets may be considered data packets from the perspective of the mesh network. This may allow mesh portal nodes to communicate spanning tree control information among themselves and with other bridges.

In some embodiments, when a mesh point wants to send a data packet for the first time to another mesh point in the same mesh network, no bridging functionality is involved. In some embodiments, these operations may be managed by the layer-2 routing protocol, such as the layer-2 AODV routing protocol, although the scope of the invention is not limited in this respect.

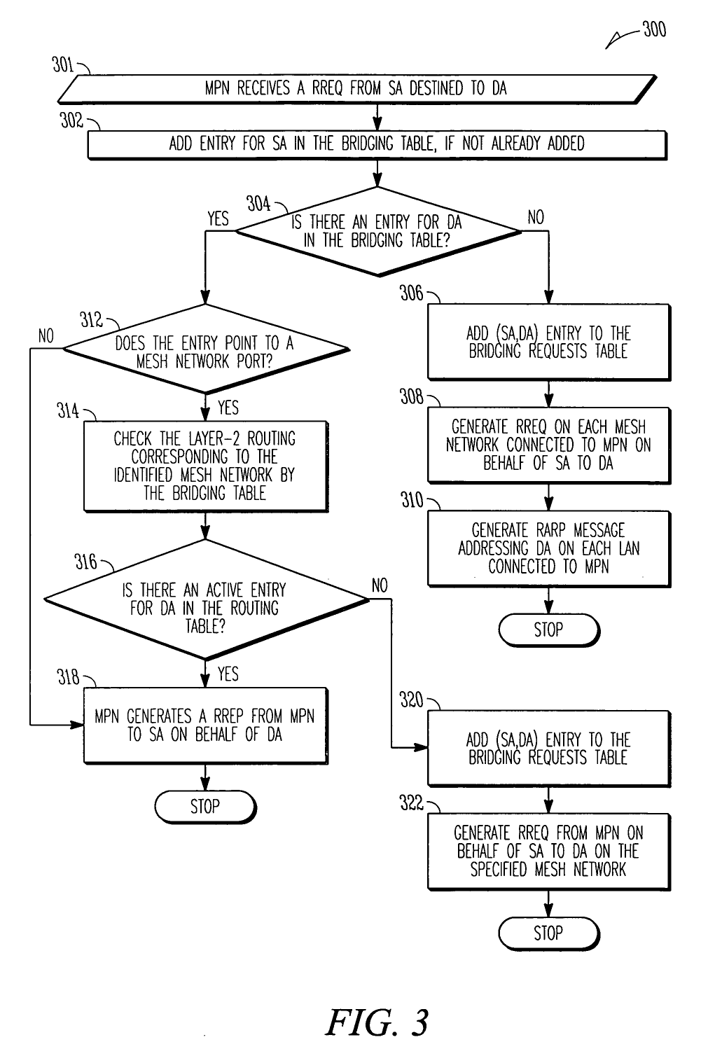

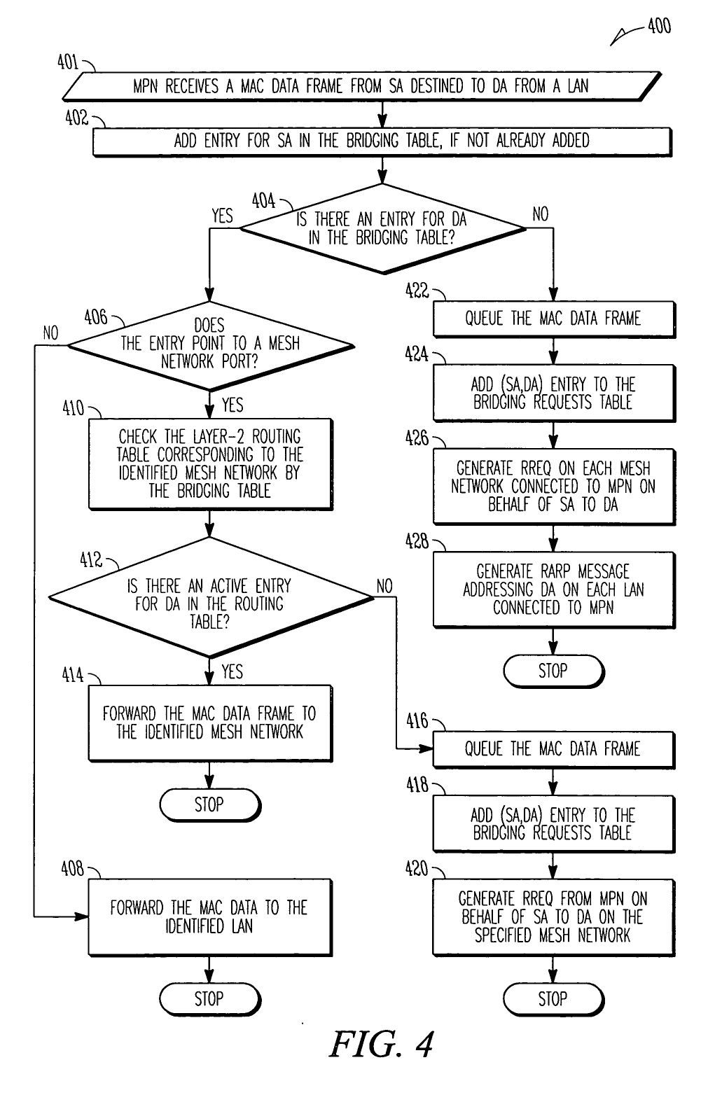

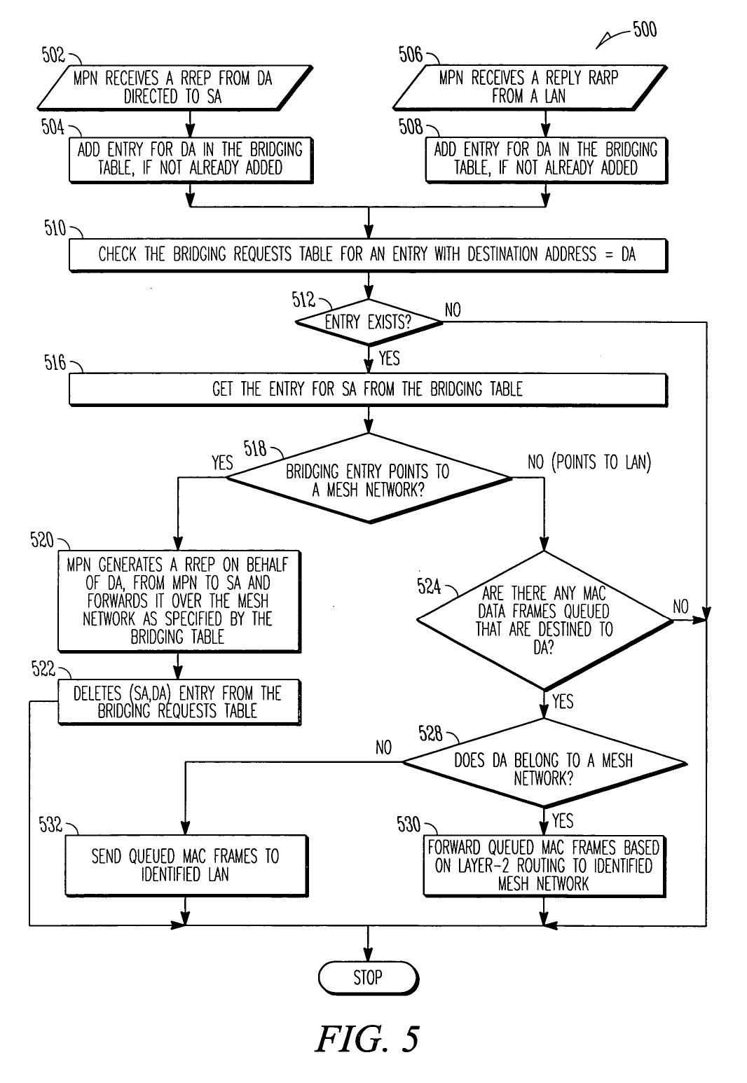

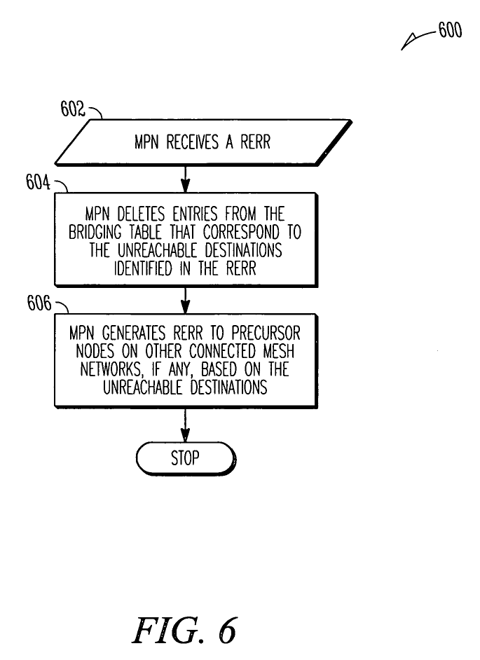

FIGS. 3, 4, 5 and 6 are flow charts of port discovery, bridging and routing procedures in accordance with some embodiments of the present invention. Procedure 300 illustrates the operations performed by a mesh portal node, such as mesh portal node 102 (FIG. 1), in response to receipt of a route request control packet (e.g., an RREQ) from a mesh network, such as wireless mesh network 108 (FIG. 1) in accordance with some embodiments of the present invention. Procedure 400 illustrates the operations performed by a mesh portal node, such as mesh portal node 102 (FIG. 1), in response to receipt of a MAC data frame from a LAN, such as LAN 114 (FIG. 1) in accordance with some embodiments of the present invention. Procedure 500 illustrates the operations performed by a mesh portal node, such as mesh portal node 102 (FIG. 1), in response to receipt of a route reply control packet (e.g., an RREP) from a mesh network, such as wireless mesh network 106 (FIG. 1), or in response to receipt of a reply address resolution protocol packet (e.g., an RARP) from a LAN, such as LAN 116 (FIG. 1), in accordance with some embodiments of the present invention. Procedure 600 illustrates the operations performed by a mesh portal node, such as mesh portal node 102 (FIG. 1), in response to receipt of a route error control packet (e.g., an RERR) from a mesh network, such as wireless mesh network 106 (FIG. 1), in accordance with some embodiments of the present invention. In some embodiments, procedures 300 (FIG. 3), 400 (FIG. 4), 500 (FIG. 5) and 600 (FIG. 6) may be performed concurrently by one or more mesh portal nodes. Although the individual operations of procedures 300, 400, 500 and 600 are illustrated and described as separate operations, one or more of the individual operations may be performed concurrently, and nothing requires that the operations be performed in the order illustrated.

In some embodiments, when a mesh point wants to send a data packet for the first time to a layer-2 address outside its mesh network, the source mesh point does not need to be aware that bridging is being performed by a mesh portal node. In these embodiments, the source mesh point may initiate route discovery as if it thinks the destination node is in the same mesh network. In these embodiments, the source mesh point sends a route request control packet (e.g., an RREQ) with the intent to establish a path to the destination node.

Referring to procedure 300 (FIG. 3), a mesh portal node (MPN) may receive a route request control (RREQ) packet in operation 301. In response to receipt of the route request control packet in operation 301, the mesh portal node may add an entry for the source address (SA) in the bridging table if no entry exists in operation 302. The mesh portal node may also query its bridging table for the associated destination address (DA) in operation 304. If the mesh portal node finds the destination address of the route request control packet in its bridging table, in operation 312, it may determine when a corresponding port is a mesh network port or other LAN technology port. When operation 312 determines that the port is a legacy LAN port, the mesh portal node may act as a layer-2 proxy routing node and may send a proxy route reply control packet as if it is the destination node in operation 318. In operation 314, when the port is a mesh network port connecting the mesh portal node to another mesh network, the mesh portal node may query the layer-2 routing table that belongs to the mesh network associated with the port identified in its bridging table. In operation 316, if the mesh portal node finds an active entry in its layer-2 routing table for that destination node, the mesh portal node may again send a route reply control packet (e.g., a proxy route reply control packet) in operation 318 as if it is the destination node. In some embodiments, the use of an AODV routing protocol may allow intermediate nodes to respond on behalf of the destination node if they have an established path to that destination. If the mesh portal node does not find an active entry for destination mesh point in the layer-2 routing table corresponding to the correct mesh network, in operation 320 it may add the destination address and source address as they appear in the route request control packet to the bridging requests table. In operation 322, the mesh portal node may generate a route request control packet to the destination mesh point on the corresponding mesh network.

When a mesh portal node does not find the destination address of the route request control packet in its bridging table in operation 304, it may assume that the destination node may exist at any connected network and may perform operation 306. In operation 306, the mesh portal node may first add a new entry into its bridging requests table using the pair of source and destination addresses. In operation 308, the mesh portal node may generate a route request control packet on every connected mesh network where the source address of this route request control packet is the address of the mesh portal node and the destination address is the destination address in the received route request control packet. The mesh portal node may also generate a reverse address resolution protocol (RARP) message on every connected LAN segment in operation 310, where the target MAC address of the reverse address resolution protocol is the destination address of the received route request control packet.

Referring to procedure 400 (FIG. 4), when a node in a LAN segment (e.g., LAN 112, 114 or 116) sends a data packet for the first time to a mesh point in a bridged mesh network, a node residing in the LAN segment may send a MAC data frame addressing a mesh point in a bridged mesh network. In these embodiments, the corresponding mesh portal node may receive this MAC data frame in operation 401. In response to receipt of the MAC data frame in operation 401, the mesh portal node may add an entry for the source address in the bridging table if there is no entry in operation 402. In operation 404, it may check its bridging table for the destination address. If the mesh portal node finds a matching entry in its bridging table, operation 406 may determine whether the entry point is a mesh network port. When the entry point is a mesh network port, operation 410 may be performed. In operation 410, the mesh portal node may check the corresponding layer-2 routing table associated with the mesh network port identified in the bridging table. If the mesh portal node finds an active entry in the layer-2 routing table for the destination mesh point in operation 412, it may proceed to forward the data frames in operation 414. If the mesh portal node does not find an active entry in the corresponding layer-2 routing table for the destination mesh point in operation 412, operation 416 may be performed. In operation 416, the mesh portal node may queue the MAC data frame. In operation 418, it may add an entry to its bridging requests table using the source and destination addresses from the received MAC data frame. In operation 420, the mesh portal node may generate a route request control packet over the corresponding mesh network. In some embodiments, when operation 406 determines that the destination address is not within a LAN, operation 408 forwards the MAC data to the identified LAN.

In operation 404, when the mesh portal node does not find an entry for the destination address in its bridging table, the mesh portal node may first queue the MAC data frame in operation 422. In operation 424, it may add an entry in its bridging requests table for the source/destination pair. In operation 426, the mesh portal node may generate a route request control packet on each connected mesh network. The source address of the route request control packet may be the address of the mesh portal node and the destination address may be the destination address in the MAC data frame. Additionally, in operation 428, the mesh portal node may generate a reverse address resolution protocol message on each connected LAN segment, where the target MAC address of reverse address resolution protocol is the destination address in the received MAC data frame, although the scope of the invention is not limited in this respect.

Referring to procedure 500 (FIG. 5), a mesh portal node may receive a route reply control packet from a destination node in operation 502. In response to receipt of the route reply control packet in operation 502, the mesh portal node may add an entry for the destination address in the bridging table if no entry exists in operation 504 and may then perform operation 510.

When the mesh portal node receives a receives a reply-reverse address resolution protocol message from one of the connected LAN segment in operation 506, the mesh portal node may add an entry for the destination address in the bridging table (if not already added) in operation 508 and operation 510 may then be performed.

In operation 510, the mesh portal node may check its bridging requests table and may find a matching destination address entry, which indicates there may be a pending bridge learning request for the benefit of the source address in the corresponding entry in the bridging requests table.

Operation 512 determines whether a matching destination address was found in operation 510. When a matching destination address is found, in operation 516, the mesh portal mode may retrieve a pair of source and destination addresses from its bridging requests table. Operation 518 determines whether the entry retrieved in operation 516 points to a wireless mesh network. When the entry points to a wireless mesh network, operation 520 may be performed. In operation 520, the mesh port node may generate a route reply control packet acting as layer-2 proxy using the pair of source and destination addresses from its bridging requests table retrieved in operation 516. In operation 522, the mesh portal node may delete the corresponding entry from its bridging requests table.

When operation 518 determines that the source address is within a LAN segment, the mesh portal node may then determine when there are any MAC data frames queued for the destination address in operation 524. When operation 524 determines that there are queued MAC data frames, operation 528 may determine whether the destination address belongs to a mesh network. When operation 528 determines that the destination address belongs to a mesh network, the mesh portal node may forward the queued MAC frames based on layer-2 routing to the next hop on the corresponding mesh network in operation 530. If any MAC data frame is queued for more than a predetermined time (e.g., a bridge learning timeout time), the frame may be dropped by the mesh portal node, although the scope of the invention is not limited in this respect. When there are no queued MAC data frames determined in operation 524, no additional operations need to be performed. When operation 528 determines that the destination address does not belong to a mesh network, the queued MAC frames may be sent to an identified LAN in operation 532. In some embodiments, the mesh portal node may determine whether there are any queued MAC data frames instead of generating a route request control packet because it may determine from the source address that the destination is on a LAN segment and not on a mesh network.

Referring to procedure 600 (FIG. 6), when a mesh portal node generates route request control packets and route reply control packets on behalf of other bridged mesh points as described above, it may also maintain a list of precursor nodes as if the mesh portal node is part of a larger mesh network. In these embodiments, a mesh portal node may receive a route error control packet (e.g., an RERR) in operation 602. When a route error control packet is received in operation 602, the mesh portal node may delete the bridging entries in operation 604 that correspond to unreachable destinations (i.e., as identified by the route error control packet) from its bridging table to help prevent the mesh portal node from relying on stale bridging information. In operation 606, the mesh portal node may generate a route error control packet to precursor nodes on other connected mesh networks (if any) based on the unreachable destinations. In addition, the mesh portal node may also forward route error control packet as part of operation 606 to the correct precursor nodes on other connected mesh networks when applicable.

The following examples may help illustrate some embodiments of the present invention. Referring back to FIGS. 1 and 2A, in some embodiments, when mesh point 109 has a data packet destined to mesh point 107, mesh point 109 generates a route request control packet that may be received by mesh portal node 102. Mesh portal node 102 checks its bridging table and finds an entry for mesh point 107 that indicates the correct port is to wireless mesh network 106. Mesh portal node 102 may check layer-2 routing table 208 for wireless mesh network 106 and if it finds an active entry for mesh point 107, mesh portal node 102 may generate a route reply control packet toward mesh point 109, which ultimately establishes an active path, and mesh portal node 102 may start sending the data packets. If mesh portal node 102 does not find an active entry in layer-2 routing table 208, mesh portal node 102 may add the pair (i.e., mesh point 109 and mesh point 107) to bridging requests table 212 and may generate a route request control packet toward mesh point 107 with mesh portal node 102 as the source node. Mesh portal node 102 may only need to send this route request control packet over wireless mesh network 106, although the scope of the invention is not limited in this respect. Mesh portal node 102 may ultimately receive a route reply control packet from mesh point 107 and may check bridging requests table 212 and find an entry with the destination address for mesh point 107. In response, mesh portal node 102 generates a route reply control packet toward mesh point 109 on wireless mesh network 108. Mesh portal node 102 knows that mesh point 109 is on wireless mesh network 108 from bridging table 206. Mesh portal node 102 may then delete the corresponding entry from bridging requests table 212.

In some embodiments, when mesh point 109 has data to send to mesh point 107 with no path defined, mesh point 109 may generate a route request control packet, which may be received by mesh portal node 102. Mesh portal node 102 then checks its bridging table and finds no entry for mesh point 107, it adds the pair (e.g., mesh point 109, mesh point 107) to its bridging requests table and generates route request control packets on both wireless mesh network 106 and wireless mesh network 110. Additionally, mesh portal node 102 may generate reverse address resolution protocol messages on both LAN 114 and LAN 116. When mesh portal node 104 receives the route request control packet that was sent over wireless mesh network 110 from mesh portal node 102, mesh portal node 104 may also send a reverse address resolution protocol message on LAN 112. Wireless mesh network 106 is the one that contains mesh point 107 and thus mesh portal node 102 may end up receiving a route reply control packet from mesh point 109. After checking its bridging requests table, mesh portal node 102 may find a match with a source address from wireless mesh network 108 (e.g., based on the bridging table data) so mesh portal node 102 may proceed with generating route reply control packet toward mesh point 109. Mesh portal node 102 may then delete the corresponding entry from its bridging requests table.

In some embodiments, when mesh point 109 has data to send to LAN station 115, mesh point 109 may generate a route request control packet that may be received by mesh portal node 102. In this example, mesh portal node 102 does not have an entry in its bridging table for LAN station 115, so mesh portal node 102 adds a new entry in its bridging requests table and may generate route request control packets on wireless mesh network 106 and wireless mesh network 110. Additionally mesh portal node 102 may generate reverse address resolution protocol packets on LAN 114 and LAN 116. Mesh portal node 104 may end up receiving a route request control packet (from mesh portal node 102 over wireless mesh network 110) and generating a reverse address resolution protocol on LAN 112. When mesh portal node 102 receives a reply-reverse address resolution protocol from LAN station 115, mesh portal node 102 may check its bridging requests table and may find a matching entry. Mesh portal node 102 may then generate a route reply control packet on behalf of LAN station 115 toward mesh point 109 and may delete the corresponding entry from its bridging requests table.

In some of the example embodiments discussed above, when a source mesh point receives a route reply control packet from a mesh portal node, it may update its layer-2 routing table with the next hop information without knowing that the destination is outside its direct mesh network.

In some embodiments, when a mesh portal node receives a data packet from a mesh point addressing a destination mesh point in another bridged mesh network, the source mesh point may have an active path established toward the destination. This may imply that any intermediate nodes have already established a path toward that destination. Once the mesh portal node receives the data packet, it may recognize that it is targeting another bridged mesh network, may access the corresponding layer-2 routing table and may proceed with forwarding the data packet toward the next hop on that bridged mesh network. The forwarding on bridged mesh networks may continue until the data packet reaches its destination.

In some embodiments, LAN station 115 may send a MAC data frame destined to mesh point 109. Mesh portal node 102 may receive the MAC data frame and may find no entry in bridging table 206. In these embodiments, mesh portal node 102 may queue the MAC data frame. This queuing happens from the mesh technology perspective as mesh portal node 102 may support conventional bridging functionality and may broadcast the frame on other traditional connected LANs. In these embodiments, mesh portal node 102 may also add an entry to its bridging requests table. The entry may include LAN station 115 and mesh point 109. Mesh portal node 102 may generate route request control packets on mesh networks 106, 108 and 110 in which the source address of the route request control packet is mesh portal node 102 and the destination address is mesh point 109. Mesh portal node 102 may also generate a reverse address resolution protocol on LAN 114. Mesh portal node 104 may receive a route request control packet and may end up sending a reverse address resolution protocol on LAN 112. Mesh portal node 102 may then receive a route reply control packet from mesh point 109 and may check its bridging requests table to find a matching entry with a source address associated with a LAN port (as indicated in its bridging table). Mesh portal node 102 may also determine when there are any queued MAC data frames destined to mesh point 109 and may forward them to the next hop on wireless mesh network 108 based on its layer-2 routing table.

In some embodiments, when a node (e.g., LAN station 115) in a LAN segment (e.g., LAN 116) sends a data packet for the first time to a node (e.g., LAN station 113) in another LAN segment (e.g., LAN 112) bridged through a mesh network, the operations described above may be performed, except that in these embodiments, more than one mesh portal node may be involved in the bridging operations. For example, when LAN station 115 sends a MAC data frame to LAN station 113, mesh portal node 102 receives the frame and may find no entry for LAN station 113 in bridging table 206. Mesh portal node 102 may queue the MAC data frame, may add a new entry in bridging requests table 212, and may generate route request control packets on wireless mesh network 108, wireless mesh network 106, and wireless mesh network 110. Additionally, mesh portal node 102 may generate a reverse address resolution protocol on LAN 114. Mesh portal node 104 may receive a route request control packet from mesh portal node 102 addressing LAN station 113 and mesh portal node 102 learns that LAN station 113 resides in LAN 112. Mesh portal node 104 may then generate a route reply control packet toward mesh portal node 102. When mesh portal node 102 receives a route reply control packet from mesh portal node 104, it implies that a path has been established between mesh portal node 102 and mesh portal node 104 through wireless mesh network 110. Mesh portal node 102 may check its bridging requests table and may find a matching entry. Mesh portal node 102 may also determine when there are any MAC data frames addressing LAN station 113 queued and may forward them to the next hop on wireless mesh network 110 based on the layer-2 routing table for wireless mesh network 110 of mesh portal node 102. These data frames may be unicast-forwarded over wireless mesh network 110 toward mesh portal node 104, which may end up transmitting the MAC frame over LAN 112, although the scope of the invention is not limited in this respect.

In some embodiments, when either a source mesh point generates a route request control packet or a mesh portal node generates a route request control packet, and when the generator of the route request control packet does not receive a response within a specific time, the source may regenerate the route request control packet up to a predetermined maximum number of times. In these embodiments, this route request control packet retry mechanism may add more reliability to mesh network bridging over conventional routing protocols, such as the AODV routing protocol, although the scope of the invention is not limited in this respect.

In some embodiments, when a mesh point moves and migrates from a current mesh network and joins another mesh network or even potentially ends up joining another LAN segment, the previous hop mesh point on the old mesh network may generate a route error control packet to precursor nodes. Once the corresponding mesh portal node receives this route error control packet, it may delete the entry for that mesh point from its bridging table and may also proceed and forward it to the precursor nodes on the source mesh network. Ultimately the source mesh point may receive the route error control packet and may initiate a new route discovery phase, generating a new route request control packet, which may ultimately end up finding the destination and trigger bridge learning at the correct mesh portal node as described above. In this way, the bridging functionality provided by mesh portal nodes 102 and 104 efficiently and transparently supports the mobility of the mesh points.

In some embodiments, mesh portal node 200 (FIG. 2A) may use the dynamics of a layer-2 AODV routing protocol or any of its metric-based variants to achieve an efficient mesh network bridging with other mesh networks and other LANs, although the scope of the invention is not limited in this respect. In some embodiments, the bridging provided by mesh portal node 200 (FIG. 2A) may eliminate the need for data traffic broadcasted over a mesh network and may minimize the amount of control traffic broadcasted over a mesh network to achieve transparent bridging. In some embodiments, mesh portal node 200 (FIG. 2A) may rely on the request-reply mechanism of the AODV class routing protocols to achieve efficiency and transparency and at the same time may utilize the ARP protocol to enable simple pinging of LAN stations to facilitate bridge learning, although the scope of the invention is not limited in this respect. In some embodiments, the bridging functionality may be transparent because a mesh point does not need to be aware of the existence of mesh portal nodes nor needs to be aware whether or not the destination node is inside or outside the direct mesh network. Similarly, a legacy LAN station does not need to be aware whether or not the destination is a mesh point. In some embodiments, the bridging functionality provided by mesh portal node 200 (FIG. 2A) may enable multiple mesh networks connected through one or more mesh portal nodes to run an AODV class routing protocol transparently as if they all were part of one larger mesh network, although the scope of the invention is not limited in this respect.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, computing device includes one or more processing elements coupled with computer-readable memory that may be volatile or non-volatile memory or a combination thereof.

Some embodiments of the invention may be implemented in one or a combination of hardware, firmware and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

The Abstract is provided to comply with 37 C.F.R. Section 1.72(b) requiring an abstract that may allow the reader to ascertain the nature and gist of the technical disclosure. It is submitted with the understanding that it may not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, invention may lie in less than all features of a single disclosed embodiment. Thus the following claims are hereby incorporated into the detailed description, with each claim standing on its own as a separate preferred embodiment.

What is claimed is:

1. A portal node comprising:
logic circuitry to generate a proxy route request message on behalf of a source node in response to receipt of an initial route request message; and
physical layer circuitry to send the proxy route request message to a plurality of mesh networks, the physical layer circuitry to further send a proxy route reply message on behalf of a destination node to the source node in response to receipt of an initial route reply message from the destination node.

2. The portal node of claim 1 wherein the portal node provides bridging and routing for communications among a plurality of local area networks including one or more wireless mesh networks and one or more wireline local area networks,
wherein the logic circuitry generates the proxy route request message on behalf of the source node operating within a first one of the mesh networks in response to receipt of the initial route request message received from the first mesh network,
wherein the destination node is located within a second one of the mesh networks,
wherein the physical layer circuitry sends the proxy route reply message to the source node, and
wherein the destination node generates the initial route reply message in response to receipt of the proxy route request message.

3. The portal node of claim 2 wherein the first and second mesh networks are associated, respectively, with first and second wireless mesh network ports of the physical layer circuitry,
wherein the proxy route request message associates a particular port with the destination node based on receipt of the initial route reply message.

4. The portal node of claim 2 further comprising a memory structure to store a layer-2 routing table for each of the plurality of local area networks, to store a bridging table and to store a bridging requests table,
wherein the bridging table associates media access control (MAC) layer destination addresses with ports of the portal node,
wherein the layer-2 routing table identifies MAC layer destination addresses of mesh network nodes within an associated mesh network, and
wherein the bridging requests table temporarily stores MAC layer source and destination addresses identified in initial route request messages that do not have a MAC layer destination address in the bridging table.

5. The portal node of claim 4 wherein in response to receipt of an initial route reply message that includes a destination address listed in the bridging requests table:
the logic circuitry is to add an entry to the bridging table associating the destination address listed in the bridging requests table with corresponding mesh network port;
the logic circuitry is to retrieve an associated source address from bridging table;
the logic circuitry is to generate the proxy route reply message on behalf of the destination node for transmission to the source node; and
the logic circuitry is to delete a corresponding entry in the bridging requests table for the source and destination addresses that were identified in the initial route request message.

6. The portal node of claim 1 wherein the logic circuitry implements a port discovery process in response to receipt of the initial route request message from the source node located in one of the mesh networks when no entry exists in a bridging table for a destination MAC address identified in the initial route request message.

7. The portal node of claim 6 wherein the initial route request message and the proxy route request message comprise route request control packets, and wherein the initial route reply message and the proxy route reply message comprise route reply control packets.

8. The portal node of claim 6 wherein the physical layer circuitry comprises:
one or more wired network ports for communicating with an associated one or more wireline local area networks over wired communication links; and
one or more wireless network ports for communicating with an associated one or more wireless mesh networks over wireless communication links.

9. The portal node of claim 8 wherein the wireless network ports are associated with wireless transceivers for communicating using at least one of either spread spectrum communications or orthogonal frequency division multiplexed (OFDM) communications with the associated one of the mesh networks, and
wherein the wireless communication links associated with each of the wireless mesh networks comprise substantially orthogonal communication signals.

10. The portal node of claim 8 wherein the physical layer circuitry is to further send a reverse address resolution protocol message addressing the destination address identified in the initial route request message to each of the one or more wireline local area networks when there is no entry for the destination address in the bridging table to identify a destination in a local area network to associate with a particular port.

11. The portal node of claim 10 wherein in response to receipt of a MAC data frame received from one of the wireline local area networks,
the logic circuitry is to queue the MAC data frame when there is no entry in the bridging table for the destination address identified in the MAC data frame, and
the physical layer circuitry is to send the queued MAC frame based on layer-2 routing to one of the networks identified in response to receipt of either the initial routing reply message or a reply address resolution protocol message.

12. A method of bridging a plurality of local area networks with a mesh portal node comprising:
generating a proxy route request message on behalf of a source node in response to receipt of an initial route request message;
sending the proxy route request message to a plurality of wireless mesh networks; and
sending a proxy route reply message on behalf of a destination node to the source node in response to receipt of an initial route reply message from the destination node.

13. The method of claim 12 further comprising:
providing bridging and routing for communications among the plurality of local area networks including one or more of the wireless mesh networks and one or more wireline local area networks; and
generating the proxy route request message on behalf of the source node operating within a first one of the mesh networks in response to receipt of the initial route request message received from the first mesh network,
wherein the destination node is located within a second one of the mesh networks and the proxy route reply message is sent to the source node, and
wherein the destination node generates the initial route reply message in response to receipt of the proxy route request message.

14. The method of claim 13 wherein the first and second mesh networks are associated, respectively, with first and second wireless mesh network ports of the mesh portal node, and
wherein the proxy route request message associates a particular port with the destination node based on receipt of the initial route reply message.

15. The method of claim 13 further comprising:
storing a layer-2 routing table for each of the plurality of local area networks in the mesh portal node;
storing a bridging table in the mesh portal node; and
storing a bridging requests table in the mesh portal node,
wherein the bridging table associates media access control (MAC) layer destination addresses with ports of the portal node,
wherein the layer-2 routing table identifies MAC layer destination addresses of mesh network nodes within an associated mesh network, and
wherein the bridging requests table temporarily stores MAC layer source and destination addresses identified in initial route request messages that do not have a MAC layer destination address in the bridging table.

16. The method of claim 14 wherein in response to receipt of an initial route reply message that includes a destination address listed in a bridging requests table, the method further comprises:
adding an entry to a bridging table associating the destination address listed in the bridging requests table with corresponding mesh network port;
retrieving an associated source address from the bridging table;
generating the proxy route reply message on behalf of the destination node for transmission to the source node; and
deleting a corresponding entry in the bridging requests table for the source and destination addresses that were identified in the initial route request message.

17. The method of claim 12 further comprising implementing a port discovery process in response to receipt of the initial route request message from the source node located in one of the mesh networks when no entry exists in a bridging table for a destination MAC address identified in the initial route request message.

18. The method of claim 17 wherein the initial route request message and the proxy route request message comprise route request control packets, and
wherein the initial route reply message and the proxy route reply message comprise route reply control packets.

19. The method of claim 17 further comprising:
communicating using one or more wired network ports with an associated one or more wireline local area networks over wired communication links; and
communicating using one or more wireless network ports for communicating with an associated one or more wireless mesh networks over wireless communication links.

20. The method of claim 19 wherein the wireless network ports are associated with wireless transceivers for communicating using at least one of either spread spectrum communications or orthogonal frequency division multiplexed (OFDM) communications with the associated one of the mesh networks, and
wherein the wireless communication links associated with each of the wireless mesh networks comprise substantially orthogonal communication signals.

21. The method of claim 19 further comprising sending a reverse address resolution protocol message addressing the destination address identified in the initial route request message to each of the one or more wireline local area networks when there is no entry for the destination address in the bridging table to identify a destination in a local area network to associate with a particular port.

22. The method of claim 21 wherein in response to receipt of a MAC data frame received from one of the wireline local area networks, the method further comprises:
queuing the MAC data frame when there is no entry in the bridging table for the destination address identified in the MAC data frame; and
sending the queued MAC frame based on layer-2 routing to one of the networks identified in response to receipt of either the initial routing reply message or a reply address resolution protocol message.

23. A system comprising:
a portal node comprising logic circuitry to generate a proxy route request message on behalf of a source node in response to receipt of an initial route request message, and physical layer circuitry to send the proxy route request message to a plurality of mesh networks, the physical layer circuitry to further send a proxy route reply message on behalf of a destination node to the source node in response to receipt of an initial route reply message from the destination node; and
a substantially omnidirectional antenna coupled to the physical layer circuitry to receive the initial route request message.

24. The system of claim 23 wherein the portal node provides bridging and routing for communications among a plurality of local area networks including one or more wireless mesh networks and one or more wireline local area networks,
wherein the logic circuitry generates the proxy route request message on behalf of the source node operating within a first one of the mesh networks in response to receipt of the initial route request message received from the first mesh network,
wherein the destination node is located within a second one of the mesh networks and wherein the physical layer circuitry sends the proxy route reply message to the source node, and
wherein the destination node generates the initial route reply message in response to receipt of the proxy route request message.

25. The system of claim 24 wherein the first and second mesh networks are associated, respectively, with first and second wireless mesh network ports of the physical layer circuitry,
wherein the proxy route request message associates a particular port with the destination node based on receipt of the initial route reply message.

26. The system of claim 24 further comprising a memory structure to store a layer-2 routing table for each of the plurality of local area networks, to store a bridging table and to store a bridging requests table,
wherein the bridging table associates media access control (MAC) layer destination addresses with ports of the portal node,
wherein the layer-2 routing table identifies MAC layer destination addresses of mesh network nodes within an associated mesh network, and
wherein the bridging requests table temporarily stores MAC layer source and destination addresses identified in initial route request messages that do not have a MAC layer destination address in the bridging table.

27. A machine-accessible medium that provides instructions, which when accessed, cause a machine to bridge a plurality of local area networks, the instructions causing the machine to:
generate a proxy route request message on behalf of a source node in response to receipt of an initial route request message;
send the proxy route request message to a plurality of mesh networks; and
send a proxy route reply message on behalf of a destination node to the source node in response to receipt of an initial route reply message from the destination node.

28. The machine-accessible medium of claim 27 wherein the instructions, when further accessed cause the machine to:
provide bridging and routing for communications among a plurality of local area networks including one or more wireless mesh networks and one or more wireline local area networks; and
generate the proxy route request message on behalf of the source node operating within a first one of the mesh networks in response to receipt of the initial route request message received from the first mesh network,
wherein the destination node is located within a second one of the mesh networks and the proxy route reply message is sent to the source node, and
wherein the destination node generates the initial route reply message in response to receipt of the proxy route request message.

29. The machine-accessible medium of claim 28 wherein the first and second mesh networks are associated, respectively, with first and second wireless mesh network ports, and
wherein the proxy route request message associates a particular port with the destination node based on receipt of the initial route reply message.

30. The machine-accessible medium of claim 28 wherein the instructions, when further accessed cause the machine to:
store a layer-2 routing table for each of the plurality of local area networks in the mesh portal node;
store a bridging table in the mesh portal node; and
store a bridging requests table in the mesh portal node,
wherein the bridging table associates media access control (MAC) layer destination addresses with ports of the portal node,
wherein the layer-2 routing table identifies MAC layer destination addresses of mesh network nodes within an associated mesh network, and
wherein the bridging requests table temporarily stores MAC layer source and destination addresses identified in initial route request messages that do not have a MAC layer destination address in the bridging table.
